(19) United States
(12) Patent Application Publication
(10) Pub. No.: US 2017/0257259 A1
(43) Pub. Date: Sep. 7, 2017

(54) COMPUTER SYSTEM, GATEWAY APPARATUS, AND SERVER APPARATUS

(71) Applicant: Hitachi, Ltd., Tokyo (JP)

(72) Inventors: Nodoka MIMURA, Tokyo (JP); Masashi YANO, Tokyo (JP); Masayuki TAKASE, Tokyo (JP); Taisuke UETA, Tokyo (JP)

(21) Appl. No.: 15/337,149

(22) Filed: Oct. 28, 2016

(30) Foreign Application Priority Data
Mar. 7, 2016 (JP) 2016-043041

(51) Int. Cl. H04L 12/24

(52) U.S. Cl. CPC H04L 41/0627; H04L 67/12

(57) ABSTRACT

To reduce a load of an inspection process on a server apparatus . A computer system includes a server apparatus, a gateway apparatus, and a plurality of devices coupled to the gateway apparatus. The gateway apparatus retains a range of a normal value of a device, calculated based on device information, for the plurality of devices, and when device information related to a certain device is not included in a range of a normal value of the device, notifies the server apparatus of the fact that an anomaly with respect to the device has been detected. When the server apparatus receives from the gateway apparatus a notification of the fact that an anomaly has been detected, the server apparatus inspects device information related to the device in which the anomaly had been detected.

### INCORPORATION BY REFERENCE

This application claims priority based on Japanese patent application, No. 2016-043041 filed on Mar. 7, 2016, the entire contents of which are incorporated herein by reference.

### BACKGROUND

The disclosed subject matter relates to a computer which involves data transfer.

In the Internet of Things (IoT), collection via networks of an enormous amount of various types of data measured by sensors or the like and utilization of the collected data by various companies are under consideration. In this case, it is important that the data be collected and utilized in a safe, efficient manner.

Japanese Patent Application Laid-open No. 2004-86880 discloses a system configured to protect a wide area network having a plurality of connection points with an external network from unauthorized access, the system including: a system which detects unauthorized access at each connection point and which issues, for notification, alarm information; means which stores the notified alarm information; a monitor which extracts an access status of the network from contents of communication at each connection point; and means which stores the extracted access status.

Japanese Translation of PCT Application No. 2015-513828 discloses an intrusion detection system in a field area network (FAN) in which data is transmitted by packets, the system including: a processor which analyses a packet in order to ascertain whether or not the packet conforms to sets of rules indicating an intrusion; and a database unit which stores an alert indicating an intrusion when the packet conforms to at least one rule in the sets.

### SUMMARY

Since Japanese Patent Application Laid-open No. 2004-86880 is premised on the introduction of a security measure apparatus to the end point, there is a significant increase in cost at the end point.

In Japanese Translation of PCT Application No. 2015-513828, probe information collected at the end point is transmitted to a server without modification so as to have the server implement the security measures. This means that the amount of data transfer to the server is large and a burden placed on the server due to an inspection process is also heavy.

An object of the present invention is to reduce the burden of an inspection process on a server and to ensure good scalability of an entire system.

A computer system according to an embodiment includes a server apparatus, a gateway apparatus, and a plurality of devices coupled to the gateway apparatus. The gateway apparatus retains a normal value of a device, calculated based on device information which is information related to the device, for the plurality of devices, and when device information related to a certain device is not included in a range of a normal value of the device, notifies the server apparatus of the fact that an anomaly with respect to the device has been detected. When the server apparatus receives from the gateway apparatus a notification of the fact that an anomaly has been detected, the server apparatus inspects device information related to the device in which the anomaly had been detected.

According to the teaching herein, the burden of an inspection process on a server can be reduced and good scalability of an entire system can be ensured.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a configuration example of a computer system according to the present embodiment;

FIG. 2 shows a hardware configuration example of each server included in a data center;

FIG. 3 shows a configuration example of hardware of a gateway apparatus;

FIG. 4 shows an example of functions included in a gateway apparatus;

FIG. 5 shows an example of a device information management table;

FIG. 6 shows an example of normal value setting information;

FIG. 7 shows an example of a normal value management table;

FIG. 8 shows an example of a state transition of a gateway apparatus;

FIG. 9 shows an example of a state transition of an operation and management server;

FIG. 10 is a sequence chart showing an operation example in a case where a new device is coupled to a gateway apparatus;

FIG. 11 is a sequence chart showing an operation example in a case where relearning is necessary;

FIG. 12 is a sequence chart showing an operation example of an entire computer system in a learning state;

FIG. 13 is a sequence chart showing an operation example of a computer system in a normal operating state;

FIG. 14 is a sequence chart showing an operation example of a computer system in an abnormal operating state;

FIG. 15 is a flow chart showing an operation example of an operation and management server in a learning state;

FIG. 16 is a flow chart showing an operation example of a behavior learning server in a learning state;

FIG. 17 is a flow chart showing an operation example of a gateway apparatus in a learning state;

FIG. 18 is a flow chart showing an operation example of a gateway apparatus in a normal operating state;

FIG. 19 is a flow chart showing an operation example of a gateway apparatus in an abnormal operating state;

FIG. 20 is a flow chart showing an operation example of a line accommodation server; and

FIG. 21 is a flow chart showing an operation example of an operation and management server in an abnormal operating state.

### DESCRIPTION OF THE EMBODIMENTS

Hereinafter, an example will be described.

Although information will be described below using expressions such as an “xxx table”, information may be expressed using any kind of data structure. In other words, an “xxx table”, an “xxx queue”, or an “xxx list” can also be referred to as “xxx information” in order to show that information is not dependent on data structure.

Furthermore, while the expressions “identification information”, “identifier”, “name”, and “ID” are used when describing contents of the respective pieces of information, these expressions are interchangeable.

In addition, while a “program” is sometimes used as a subject when describing a process in the following description, since a program causes prescribed processing to be performed while using at least one of a storage resource (for example, a memory) and a communication interface device as appropriate by being executed by a processor (for example, a central processing unit (CPU)), a processor or an apparatus including the processor may be used as a subject of processing. Processing performed by a processor may be partially or entirely performed by a hardware circuit. A computer program may be installed from a program source. The program source may be a program distribution server or a storage medium (for example, a portable storage medium).

Furthermore, in the following description, a set of one or more computers which manage at least one apparatus included in a computer system may be referred to as a “management system”. When a management computer displays display information, the management computer may constitute a management system. In addition, a combination of a management computer and a display computer may also constitute a management system. Furthermore, processes identical or similar to those of a management computer may be realized by a plurality of computers in order to increase speed or reliability of a management process. In this case, the plurality of computers may constitute a management system (when a display computer performs display, the display computer may also be included). In the present example, a management computer constitutes a management system. Moreover, a management computer displaying information may signify displaying information on a display device included in the management computer or transmitting display information to a display computer (for example, a client) being coupled to the management computer (for example, a server). In the case of the latter, information represented by display information is displayed by the display computer on the display device included in the display computer.

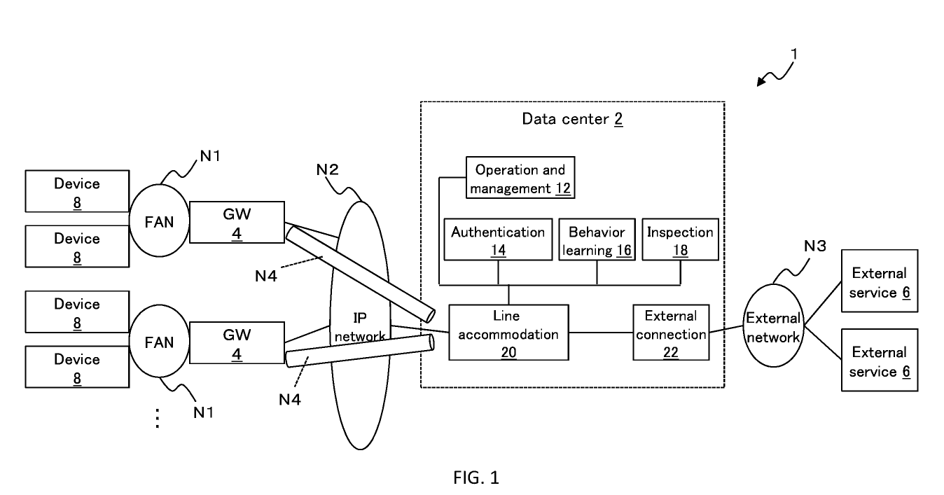

FIG. 1 shows a configuration example of a computer system 1 according to the present embodiment. The computer system 1 includes a data center 2, external service servers 6, gateway apparatuses 4, and devices 8.

The data center 2 and each external service server 6 are coupled to each other via a prescribed network N3 so as to be capable of bidirectional communication. The network N3 may be a LAN, a WAN, a combination thereof, or the like. The network N3 may be referred to as an external network.

The data center 2 and each gateway apparatus 4 are coupled to each other via a prescribed network N2 so as to be capable of bidirectional communication. The network N2 may be a LAN, a WAN, a combination thereof, or the like which transmits IP packets. The network N2 may be referred to as an IP network. The data center 2 and the gateway apparatus 4 may transmit and receive data through a secure tunnel N4 constructed between the data center 2 and the gateway apparatus 4.

The gateway apparatus 4 and each device 8 are coupled to each other via a prescribed network N1 so as to be capable of bidirectional communication. The network N1 may be referred to as a field area network (FAN).

Examples of the device 8 include a sensor node, a control device, and a switch. Examples of a sensor node include a temperature sensor, a humidity sensor, and an air pressure sensor. Examples of a control device include a temperature control device, a pressure control device, and a robot control device. Examples of a switch include a layer 2 switch, a control network switch, and a near-field wireless relay switch.

The data center 2 may include an operation and management server 12, an authentication server 14, a behavior learning server 16, an inspection server 18, a line accommodation server 20, and an external connection server 22. The respective servers 12, 14, 16, 18, 20, and 22 may be coupled by a network in the data center 2.

The operation and management server 12 is a server for operating and managing the gateway apparatus 4 and the device 8.

The authentication server 14 is a server for authenticating the gateway apparatus 4 and the device 8.

The behavior learning server 16 is a server for learning and calculating normal behavior (an average, a range, or the like of normal values) of each device 8.

The inspection server 18 is a server for inspecting the absence of problematic data in data received from the gateway apparatus 4, the device 8, the external service server 6, and the like. Examples of problematic data include data including an incorrect value, unsafe data in terms of security, and unknown data.

The line accommodation server 20 is a server used by the data center 2 to collect the secure tunnel N4 from each gateway apparatus 4. The external connection server 22 is a server for coupling the data center 2 to the external network N3. The external connection server 22 may include a firewall function.

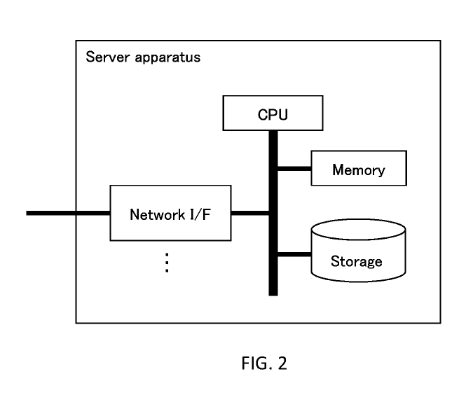

FIG. 2 shows a hardware configuration example of the respective servers 12, 14, 16, 18, 20, and 22 included in the data center 2.

A server includes a CPU, a memory, a storage, and a network I/F. These components are coupled by an internal bus that enables bidirectional communication.

The memory stores programs and data for realizing various functions of the server. Examples of the memory include a dynamic random access memory (DRAM), a magnetoresistive random access memory (MRAM), and a ferroelectric random access memory (FeRAM).

The CPU realizes various functions of the server by reading programs and data from the memory and processing the programs and data. The storage stores programs and data for realizing various functions of the server. Examples of the storage include a hard disk drive (HDD) and a solid state drive (SSD).

The network I/F is an I/F for coupling a server to a network to enable data to be transmitted to and received from another apparatus. Examples of the network I/F include an Ethernet (registered trademark) adapter and a Fibre Channel adapter.

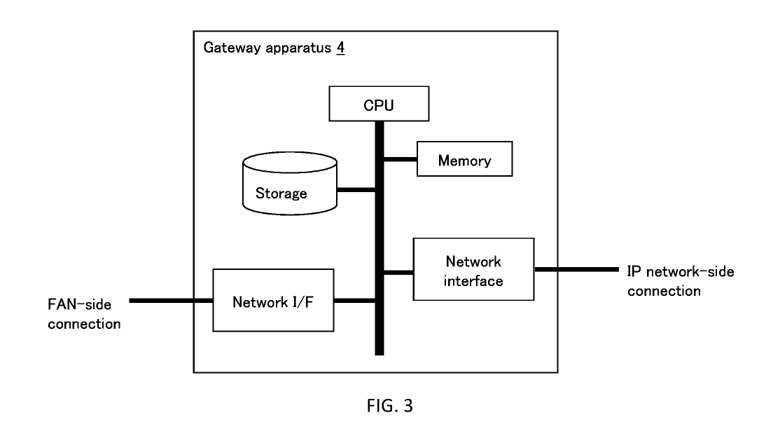

FIG. 3 shows a configuration example of hardware of the gateway apparatus 4.

The gateway apparatus 4 includes a CPU, a memory, a storage, and a network I/F. These components are coupled by an internal bus that enables bidirectional communication.

The memory stores programs and data for realizing various functions of the gateway apparatus 4. Examples of the memory include a DRAM, an MRAM, and an FeRAM.

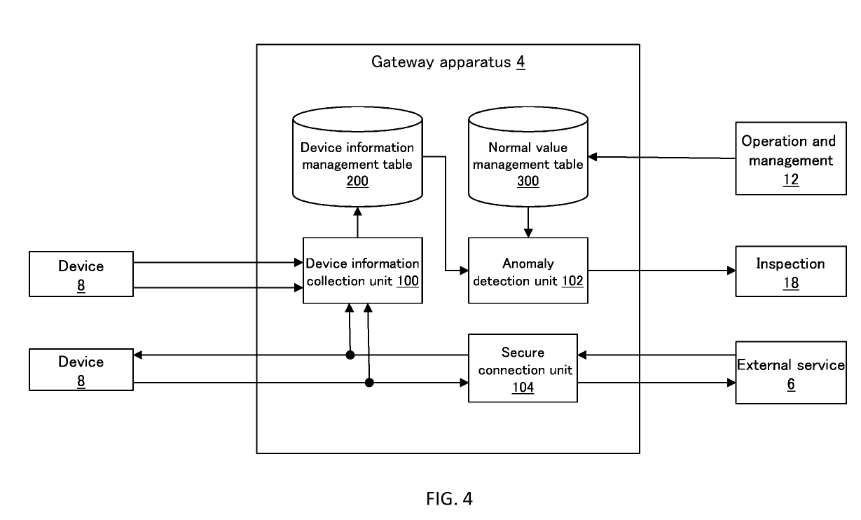

The CPU realizes various functions (refer to FIG. 4) of the gateway apparatus 4 by reading programs and data from the memory and processing the programs and data.

The storage stores programs and data for realizing various functions of the gateway apparatus 4. Examples of the storage include an HDD and an SSD.

The network I/F is an I/F for coupling a server to a network to enable data to be transmitted to and received from another apparatus. Examples of the network I/F include an Ethernet (registered trademark) adapter and a wireless LAN adapter.

The gateway apparatus 4 may include a network I/F for coupling to a FAN side and a network I/F for coupling to an IP network side.

FIG. 4 shows an example of functions included in the gateway apparatus 4.

As functions, the gateway apparatus 4 may include a device information collection unit 100, an anomaly detection unit 102, a secure connection unit 104, a device information management table 200, and a normal value management table 300.

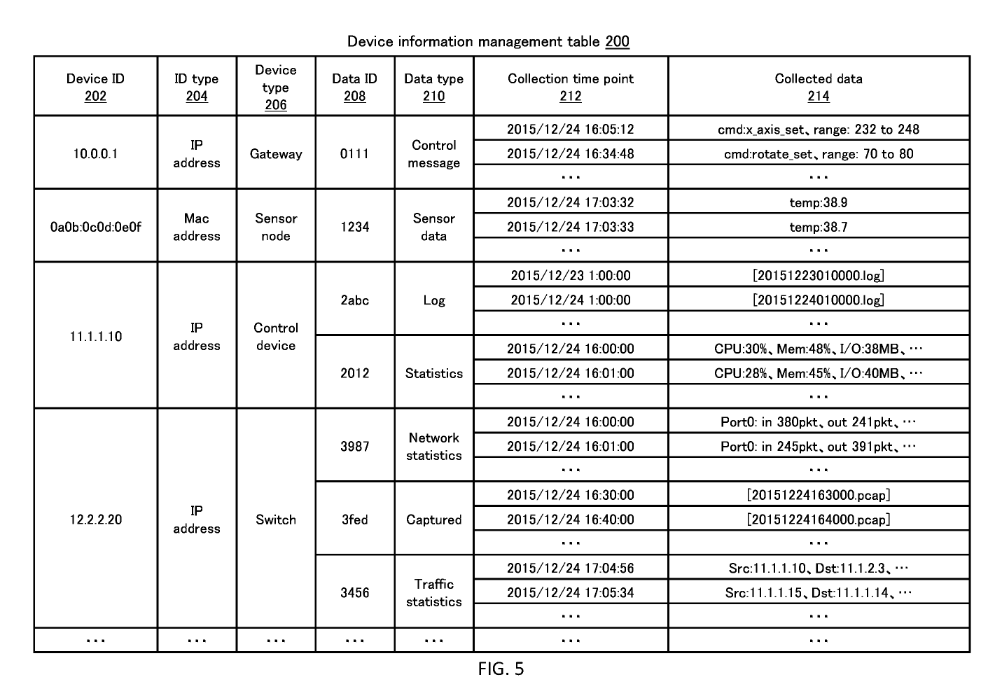

The device information management table 200 is a table for managing information related to the device 8 (referred to as “device information”) collected by the gateway apparatus 4. Details of the device information management table 200 will be provided later (refer to FIG. 5).

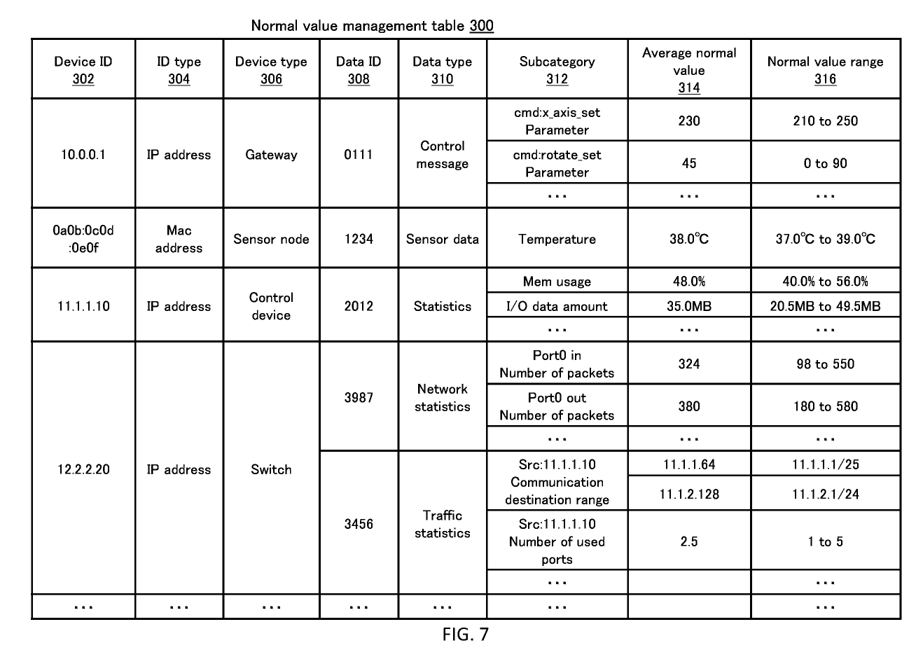

The normal value management table 300 is a table for managing a normal value of each device 8 managed by the gateway apparatus 4. Details of the normal value management table 300 will be provided later (refer to FIG. 7).

The device information collection unit 100 collects device information related to each device 8 coupled to a FAN N1 and stores the device information in the device information management table 200.

The secure connection unit 104 establishes secure connection between the gateway apparatus 4 and the data center 2. In addition, the secure connection unit 104 establishes secure connection between the gateway apparatus 4 and each device 8. Methods of establishing secure connection include a method of constructing a secure tunnel and a method of encrypting communication data.

The anomaly detection unit 102 detects a device 8 at which an anomaly may have possibly occurred by comparing a range of the normal value of each device 8 stored in the normal value management table 300 with device information of each device 8 stored in the device information management table 200.

FIG. 5 shows an example of the device information management table 200.

The device information management table 200 is a table used by the gateway apparatus 4 to manage device information. As data items (column names), the device information management table 200 may include a device ID 202, an ID type 204, a device type 206, a data ID 208, a data type 210, a collection time point 212, and collected data 214.

An ID of the device 8 that is a provider of device information is stored in the device ID 202.

A type of a value indicated by the device ID 202 is stored in the ID type 204. For example, the ID type 204 “IP address” indicates that the value stored in the device ID 202 of a same record is an IP address, and the ID type 204 “MAC address” indicates that the value stored in the device ID 202 of a same record is an MAC address.

A type of the device 8 corresponding to the value indicated by the device ID 202 is stored in the device type 206. For example, a gateway, a sensor node, a control device, or a network switch may be stored in the device type 206.

An ID of data in the same record is stored in the data ID 208.

A type of device information in the same record is stored in the data type 210. For example, a control message, sensor data, log data, statistical data, network statistical data, captured data, or traffic statistical data may be stored in the data type 210. Sensor data is device information (first device information) transmitted from the device 8 to the external service server 6. A control message is device information (second device information) transmitted from the external service server 6 to the device 8. Log data, statistical data, network statistical data, captured data, and traffic statistical data are device information (third device information) transmitted from the device 8 to the gateway apparatus 4. The third device information may be referred to as status information of the device 8.

A time point at which data in the same record had been collected is stored in the collection time point 212.

Data collected at the time point indicated by the collection time point 212 from the device 8 indicated by the device ID 202 is stored in the collected data 214.

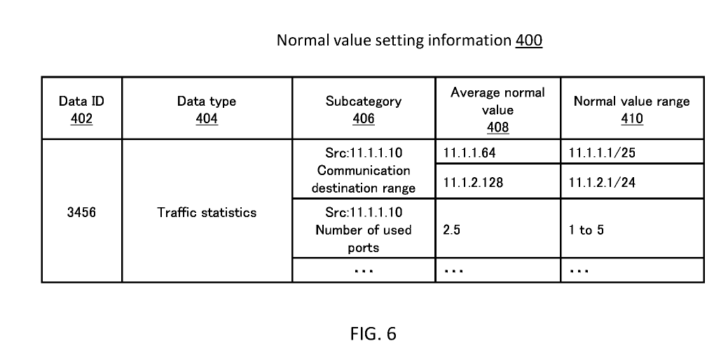

FIG. 6 shows an example of normal value setting information 400.

Normal value setting information 400 is information used by the operation and management server 12 to set a normal value to the gateway apparatus 4. As data items (column names), the normal value setting information 400 may include a data ID 402, a data type 404, a subcategory 406, an average normal value 408, and a normal value range 410.

Values similar to those of the data ID 208 and the data type 210 of the device information management table 200 are stored in the data ID 402 and the data type 404.

Equal to or more than one subcategories belonging to the type indicated by the data type 404 are stored in the subcategory 406.

An average normal value corresponding to the value of the subcategory 406 of the value indicated by the data ID 402 is stored in the average normal value 408. The average normal value 408 may be an average value, a median, a mode, or the like.

A normal value range corresponding to the value of the subcategory 406 of the value indicated by the data ID 402 is stored in the normal value range 410.

FIG. 7 shows an example of the normal value management table 300.

The normal value management table 300 is a table used by the gateway apparatus 4 to manage normal values. As data items (column names), the normal value management table 300 may include a device ID 302, an ID type 304, a device type 306, a data ID 308, a data type 310, a subcategory 312, an average normal value 314, and a normal value range 316.

Values similar to those of the device ID 202, the ID type 204, the device type 206, the data ID 208, and the data type 210 in the device information management table 200 are stored in the device ID 302, the ID type 304, the device type 306, the data ID 308, and the data type 310.

Values similar to those of the subcategory 406, the average normal value 408, and the normal value range 410 of the normal value setting information 400 are stored in the subcategory 312, the average normal value 314, and the normal value range 316. In other words, when the gateway apparatus 4 receives the normal value setting information 400 from the operation and management server 12, the gateway apparatus 4 registers the data ID 402, the data type 404, the subcategory 406, the average normal value 408, and the normal value range 410 included in the normal value setting information 400 in the normal value management table 300 in association with the data ID 308, the data type 310, the subcategory 312, the average normal value 314, and the normal value range 316 thereof.

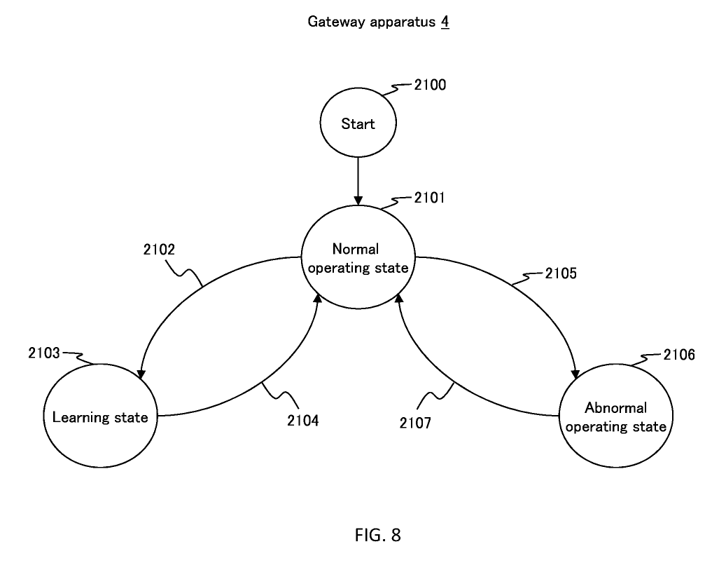

FIG. 8 shows an example of a state transition diagram of the gateway apparatus 4.

As state transitions, the gateway apparatus 4 may include a learning state 2103 and an operating state. The operating state may include a normal operating state 2101 and an abnormal operating state 2106.

The learning state 2103 is a state where the gateway apparatus 4 learns a normal value of each device 8. The operating state is a state where the gateway apparatus 4 monitors each device 8.

The gateway apparatus 4 starts from the normal operating state 2101 (2100, 2101).

When the gateway apparatus 4 receives an indication to start learning from the operation and management server 12 in the normal operating state 2101, the gateway apparatus 4 migrates to the learning state 2103 (2102).

When the gateway apparatus 4 receives an indication to end learning from the operation and management server 12 in the learning state 2103, the gateway apparatus 4 migrates to the normal operating state 2101 (2104).

When the gateway apparatus 4 detects an anomaly of the device 8 in the normal operating state 2101, the gateway apparatus 4 migrates to the abnormal operating state 2106 (2105).

When the gateway apparatus 4 receives an indication to migrate to the normal operating state 2101 from the operation and management server 12 in the abnormal operating state 2106, the gateway apparatus 4 migrates to the normal operating state 2101 (2107).

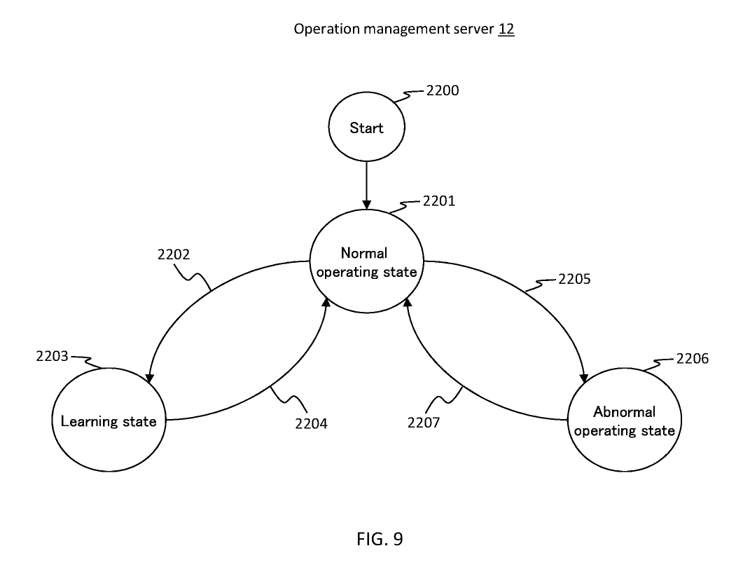

FIG. 9 shows an example of a state transition diagram of the operation and management server 12.

As state transitions, the operation and management server 12 may include a learning state 2203 and an operating state. The operating state may include a normal operating state 2201 and an abnormal operating state 2206.

The learning state 2203 is a state where the operation and management server 12 is causing the gateway apparatus 4 to learn a normal value of each device 8. The operating state is a state where the operation and management server 12 is causing the gateway apparatus 4 to monitor each device 8.

The operation and management server 12 starts from a normal operating state (2200, 2201).

When an event which causes learning to be started occurs in the normal operating state 2201, the operation and management server 12 makes a transition to the learning state 2203 and issues an indication to start learning to the gateway apparatus 4 (2203).

When the operation and management server 12 determines that learning should be ended in the learning state 2203, the operation and management server 12 issues an indication to end learning to the gateway apparatus 4 and migrates to the normal operating state 2201 (2204).

When the operation and management server 12 receives a notification of anomaly detection from the gateway apparatus 4 in the normal operating state 2201, the operation and management server 12 migrates to an abnormal operating state 2206 (2205).

When the operation and management server 12 determines that abnormal operation should be ended in the abnormal operating state 2206, the operation and management server 12 issues an indication to migrate to the normal operating state 2201 to the gateway apparatus 4 and migrates to the normal operating state 2201.

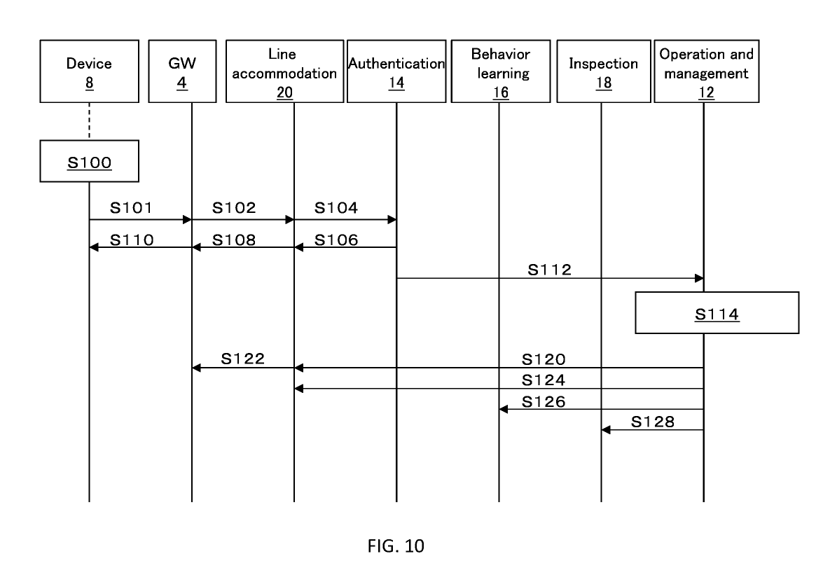

FIG. 10 is a sequence chart showing an operation example in a case where a new device 8 is coupled to the gateway apparatus 4.

When a new device 8 is coupled to the gateway apparatus 4 (S100), a normal value of the new device 8 must be learned. In this case, the computer system 1 may operate as follows.

The new device 8 issues an authentication request to the gateway apparatus 4 (S101). The gateway apparatus 4 transfers the authentication request to the authentication server 14 via the line accommodation server 20 (S102, S104).

The authentication server 14 receives and authenticates the authentication request. In addition, the authentication server 14 transmits an authentication result to the gateway apparatus 4 via the line accommodation server 20 (S106, S108). The gateway apparatus 4 transfers the authentication result to the new device 8 (S110).

In addition, when authentication is successful, the authentication server 14 notifies the operation and management server 12 of the fact that the new device 8 has been coupled to the gateway apparatus 4 (S112).

Upon receiving the notification, the operation and management server 12 makes a transition to a learning state (S114). In addition, the operation and management server 12 issues an indication to start learning to the gateway apparatus 4 (S120, S122). At this point, the operation and management server 12 may also issue an indication to start learning to the line accommodation server 20, the behavior learning server 16, and the inspection server 18 (S124, S126, S128). Due to the process described above, learning with respect to the new device 8 is started.

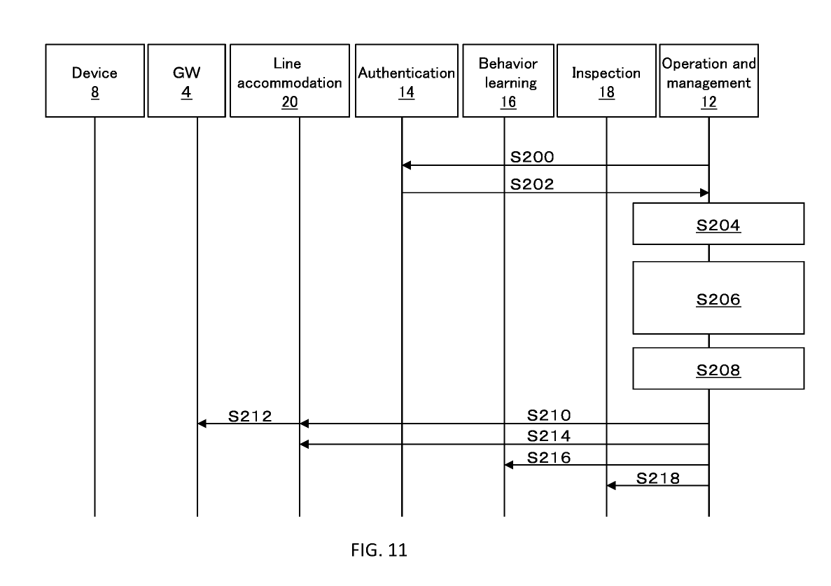

FIG. 11 is a sequence chart showing an operation example in a case where the operation and management server 12 determines that relearning is necessary.

When the normal value of the device 8 changes due to whatever cause, the normal value of the device 8 must be relearned at an appropriate timing. For example, the normal value of the device 8 may differ from season to season or the normal value of the device 8 may change due to age-related degradation. In these cases, the computer system 1 may operate as follows.

The operation and management server 12 issues a device list request to the authentication server 14 and acquires a device list from the authentication server 14 (S200, S202).

The operation and management server 12 extracts a device 8 of which the normal value may possibly change from the device list (S204).

The operation and management server 12 acquires information being a factor which may cause the normal value of the extracted device 8 to change (referred to as “change factor information”) from, for example, the external service server 6 (S206). In the case of a device 8 of which the normal value differs from season to season (such as a temperature sensor), the change factor information may be air temperature. In the case of a device 8 of which the normal value changes due to age-related degradation (such as a robot control device), the change factor information may be an installation period or a standard rate of age-related degradation of the device 8.

Based on the acquired change factor information, the operation and management server 12 determines whether or not the normal value of the extracted device 8 must be relearned. In addition, when the operation and management server 12 determines that relearning is necessary, the operation and management server 12 makes a transition to the learning state (S208).

Subsequently, the operation and management server 12 issues an indication to start learning to the gateway apparatus 4 to which the device 8 requiring relearning is coupled (S210, S212). At this point, the operation and management server 12 may also issue an indication to start learning to the line accommodation server 20, the behavior learning server 16, and the inspection server 18 (S213, S216, S218). Due to the process described above, relearning of a device is started when necessary.

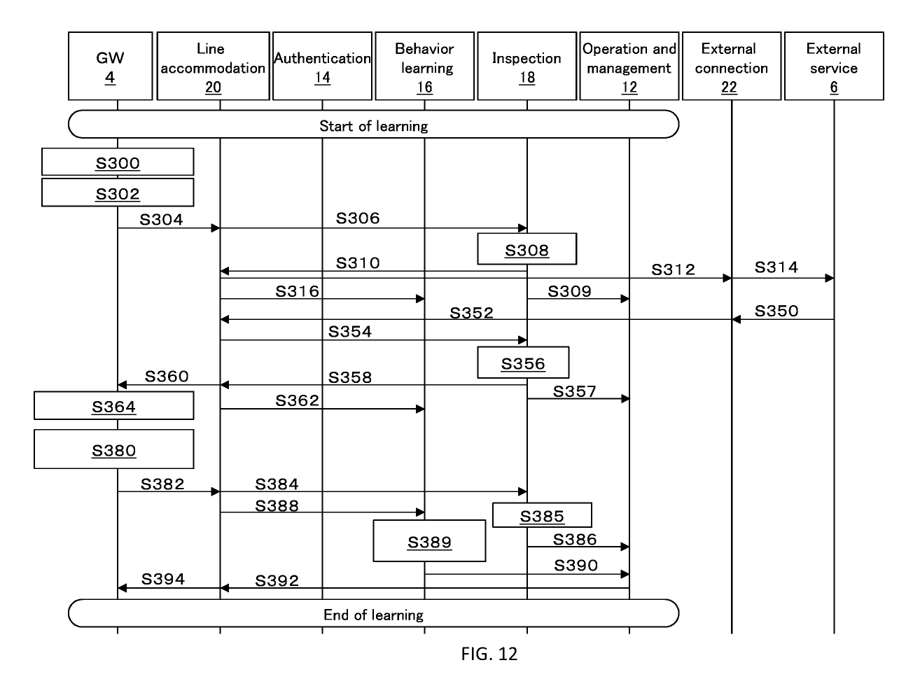

FIG. 12 is a sequence chart showing an operation example of the entire computer system in a learning state.

(A1) In the computer system 1 in a learning state, sensor data transmitted from the device 8 is processed as follows.

Sensor data transmitted from the device 8 is first received by the gateway apparatus 4 (S300). Sensor data may be data measured by the device 8 (for example, temperature, humidity, a communication rate, or a CPU clock number).

The gateway apparatus 4 selects a part of or all of the received sensor data as sensor data to be provided to the external service server 6 (S302).

The gateway apparatus 4 transfers the selected sensor data to the line accommodation server 20 (S304).

The line accommodation server 20 transfers the sensor data transferred from the gateway apparatus 4 to the inspection server 18 (S306).

The inspection server 18 inspects the transferred sensor data (S308), and when no problem is found, the inspection server 18 transfers the sensor data to the external service server 6 (S310, S312, S314). In addition, the inspection server 18 also transfers the sensor data to the behavior learning server 16 (S316). Furthermore, the inspection server 18 transmits a result of the inspection performed in S308 to the operation and management server 12 (S309).

According to the process described above, sensor data determined to be non-problematic by the inspection server 18 in the sensor data transmitted from the device 8 is transferred to the external service server 6. As a result, the external service server 6 can safely utilize sensor data. In addition, the sensor data transmitted from the device 8 is also transferred to the behavior learning server 16. As a result, the behavior learning server 16 can also utilize sensor data when learning a normal value.

(A2) In the computer system 1 in a learning state, a control message transmitted from the external service server 6 is processed as follows.

A control message transmitted from the external service server 6 is first received by the external connection server 22 (S350).

The external connection server 22 transfers the received control message to the inspection server 18 (S352, S354).

The inspection server 18 inspects the transferred control message (S356), and when no problem is found, the inspection server 18 transfers the control message to the gateway apparatus 4 (S358). In addition, the inspection server 18 also transfers the control message to the behavior learning server 16 (S358, S362). Furthermore, the inspection server 18 transmits a result of the inspection performed in S356 to the operation and management server 12 (S357).

The gateway apparatus 4 transfers the transferred control message to the device 8 (S364).

According to the process described above, a control message determined to be non-problematic by the inspection server among control messages transmitted from the external service server 6 is transferred to the device 8 via the gateway apparatus 4. As a result, the device 8 can safely execute the control message. In addition, the control message transmitted from the external service server 6 is also transferred to the behavior learning server 16. As a result, the behavior learning server 16 can also utilize the control message when learning a normal value.

(A3) In the computer system 1 in a learning state, status information transmitted from the device 8 is processed as follows.

The gateway apparatus 4 stores status information transmitted from the device 8 in the device information management table 200 (S380).

The gateway apparatus 4 transmits the status information stored in the device information management table 200 to the behavior learning server 16 and the inspection server 18 via the line accommodation server 20 (S382, S384, S388).

The inspection server 18 inspects the status information transmitted from the gateway apparatus 4 (S385) and transmits a result of the inspection to the operation and management server 12 (S386).

Based on the status information transmitted from the gateway apparatus 4, the behavior learning server 16 learns the normal value of the device 8 being a source of the device information (S389). At this point, the behavior learning server 16 may not use status information determined to be problematic in the inspection result obtained in S386 for learning a normal value. Accordingly, a correct normal value can be learned.

Subsequently, the behavior learning server 16 transmits a learning result (a normal value range, an average normal value, or the like of the device 8) to the operation and management server 12 (S390).

The operation and management server 12 generates normal value setting information 400 based on the learning result transmitted from the behavior learning server 16. In addition, the operation and management server 12 transmits the generated normal value setting information 400 to the gateway apparatus 4 via the line accommodation server 20 (S392, S394).

The gateway apparatus 4 registers the normal value setting information 400 transmitted from the operation and management server 12 in the normal value management table 300. Due to the process described above, the gateway apparatus 4 in a learning state can learn a normal value of each device 8.

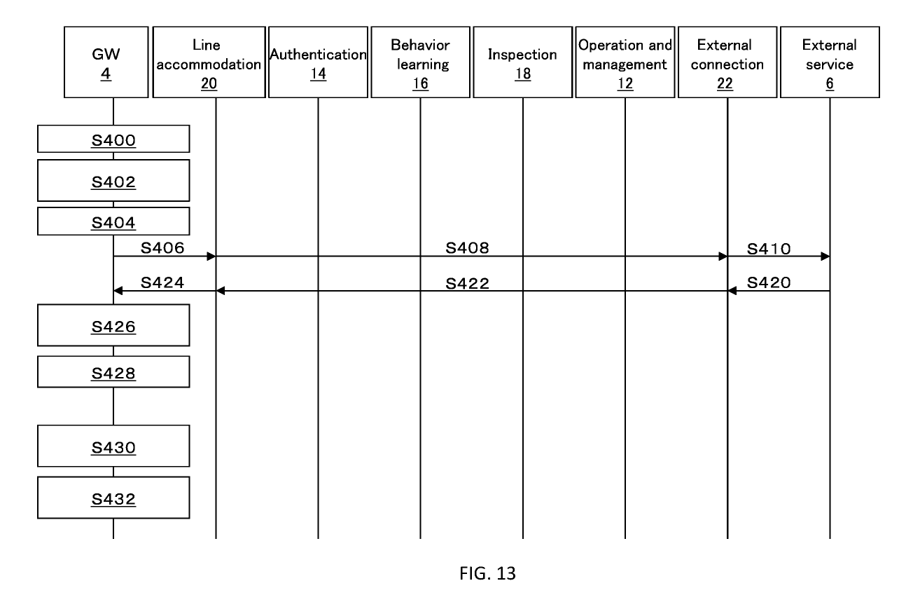

FIG. 13 is a sequence chart showing an operation example of the entire computer system 1 in a normal operating state.

(B1) In the computer system 1 in a normal operating state, sensor data transmitted from the device 8 is processed as follows.

Sensor data transmitted from the device 8 is first received by the gateway apparatus 4 (S400). The gateway apparatus 4 refers to the normal value management table 300 and calculates a degree of deviation of the received sensor data from the normal value range 316 and/or the average normal value 314 (S402). The gateway apparatus 4 selects sensor data of which the calculated degree of deviation is within a statistically normal range (S404). Subsequently, the gateway apparatus 4 transfers the selected sensor data to the external service server 6 via the line accommodation server 20 and the external connection server 22 (S408, S410).

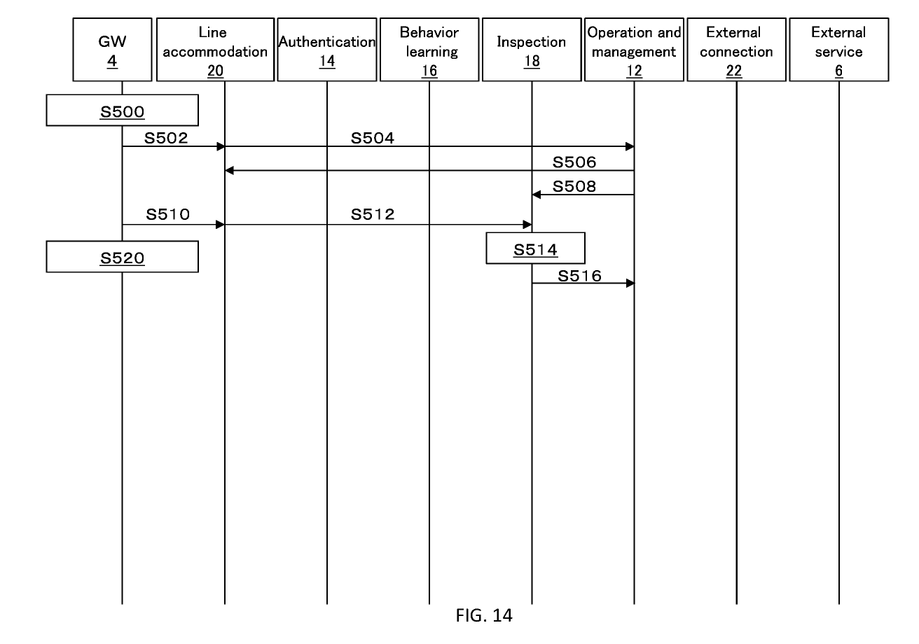

When the gateway apparatus 4 detects sensor data of which the degree of deviation calculated in S402 is not within a statistically normal range, the gateway apparatus 4 may migrate to an abnormal operating state and start the process shown in FIG. 14.

(B2) In the computer system 1 in a normal operating state, a control message transmitted from the external service server 6 is processed as follows.

A control message transmitted from the external service server 6 is transferred to the gateway apparatus 4 via the external connection server 22 and the line accommodation server 20 (S420, S422).

The gateway apparatus 4 refers to the normal value management table 300 and calculates a degree of deviation of the control message transmitted from the external service server 6 from the normal value range 316 and/or the average normal value 314 (S426). The gateway apparatus 4 transfers a control message of which the calculated degree of deviation is within a statistically normal range to the device 8 (S428).

When the gateway apparatus 4 detects a control message of which the degree of deviation calculated in S426 is not within a statistically normal range, the gateway apparatus 4 may migrate to an abnormal operating state and start the process shown in FIG. 14.

(B3) In the computer system 1 in a normal operating state, status information transmitted from the device 8 is processed as follows.

The gateway apparatus 4 receives status information from the device 8 and stores the status information in the device information management table 200 (S430). The gateway apparatus 4 refers to the normal value management table 300 and calculates a degree of deviation of the received status information from the normal value range 316 and/or the average normal value 314 (S432).

When the gateway apparatus 4 detects status information of which the degree of deviation calculated in S432 is not within a statistically normal range, the gateway apparatus 4 may migrate to an abnormal operating state and start the process shown in FIG. 14.

According to the process shown in FIG. 13, since a data inspection process can be distributed among the respective gateway apparatuses 4, a processing load on the inspection server 18 can be reduced. In other words, good scalability of the computer system 1 can be ensured.

FIG. 14 is a sequence chart showing an operation example of the entire computer system 1 in an abnormal operating state.

When the gateway apparatus 4 detects an anomaly (when a degree of deviation is not within a normal range), the gateway apparatus 4 migrates to an abnormal operating state (S500). In addition, the gateway apparatus 4 notifies the operation and management server 12 of the fact that an anomaly has been detected (S502, S504).

When the operation and management server 12 receives the notification of anomaly detection, the operation and management server 12 migrates to the abnormal operating state. Subsequently, the operation and management server 12 issues an indication to start an inspection to the inspection server 18 and the line accommodation server 20 (S506, S508).

The gateway apparatus 4 transmits the collected data 214 which is stored in the device information management table 200 and which includes at least the collection time point 212 at which the anomaly had been detected to the inspection server 18 (S510, S512). The collected data 214 may include at least one of sensor data, a control message, and device information.

The inspection server 18 inspects the collected data transmitted from the gateway apparatus 4 (S514) and transmits a result of the inspection to the operation and management server 12 (S516).

Moreover, as described with reference to (A1) to (A3) in FIG. 12, in the computer system 1 in an abnormal operating state, sensor data transmitted from the device 8, a control message transmitted from the external service server 6, and status information transmitted from the device 8 may be inspected by the inspection server 18. In addition, as described with reference to (A1) to (A3) in FIG. 12, the inspection server 18 may transmit results of the inspections to the operation and management server 12.

According to the process shown in FIG. 14, when the gateway apparatus 4 detects an anomaly, the detected anomaly can be inspected in greater detail by the inspection server 18. For example, an inspection can be performed as to whether an anomaly of data detected by the gateway apparatus 4 represents a degree of deviation accidentally being outside of a normal range (an erroneous detection) or represents an occurrence of a true abnormality.

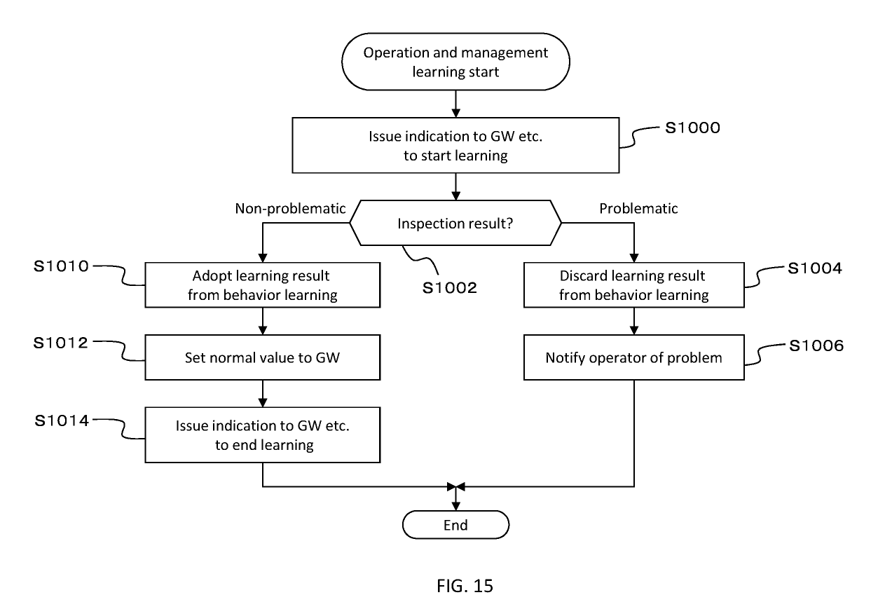

FIG. 15 is a flow chart showing an operation example of the operation and management server 12 in a learning state.

The operation and management server 12 issues an indication to start learning (to migrate to a learning state) to the gateway apparatus 4 that is a processing target, the line accommodation server 20, the behavior learning server 16, and the inspection server 18 (S1000).

The operation and management server 12 determines whether or not problematic data is present based on an inspection result received from the inspection server 18 (S1002).

When the operation and management server 12 determines that problematic data is present (S1002: Problematic), the operation and management server 12 discards a learning result based on the problematic data in a learning result received from the behavior learning server 16 (S1004). Subsequently, the operation and management server 12 notifies a operator of the fact that there is a problematic inspection result (S1006), and ends the present process.

When the operation and management server 12 determines that problematic data is not present (S1002: Non-problematic), the operation and management server 12 adopts the learning result received from the behavior learning server 16 (S1010). In addition, the operation and management server 12 generates normal value setting information 400 based on the adopted learning result and transmits the generated normal value setting information 400 to the gateway apparatus 4 that is the processing target (S1012). Furthermore, the operation and management server 12 issues an indication to end learning (in other words, to make a transition to a normal operating state) to the gateway apparatus 4 that is the processing target, the line accommodation server 20, the behavior learning server 16, and the inspection server 18 (S1014), and ends the present process.

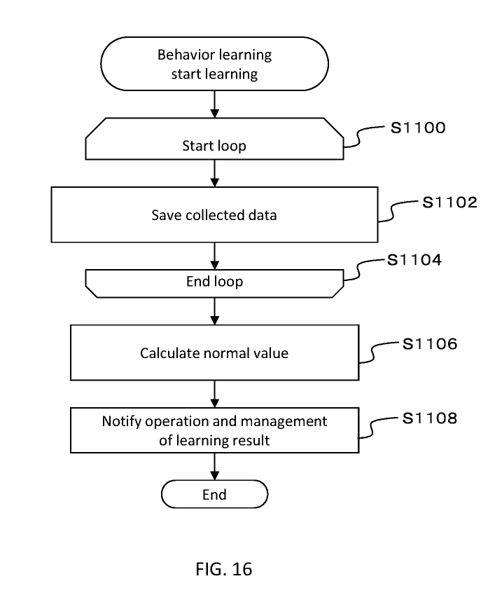

FIG. 16 is a flow chart showing an operation example of the behavior learning server 16 in a learning state.

During a prescribed learning period, the behavior learning server 16 receives sensor data, a control message, status information (a device log, statistical information, traffic information of a FAN, and the like), or the like transmitted from the gateway apparatus 4 via the inspection server 18, and stores the received information in a storage device (S1100, S1102, S1104).

After the learning period expires, the behavior learning server 16 calculates an average normal value and a normal value range from the information stored in the storage device (S1106). The behavior learning server 16 may calculate an average normal value and a normal value range using statistical analysis methods such as cluster analysis on the information stored in the storage device.

The behavior learning server 16 transmits a learning result including the calculated average normal value and normal value range to the operation and management server 12 (S1108).

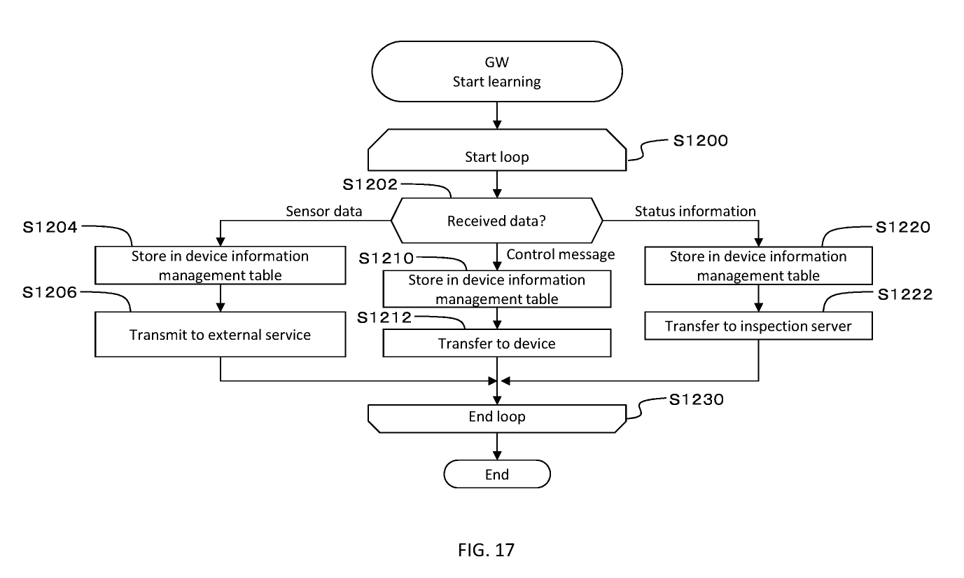

FIG. 17 is a flow chart showing an operation example of the gateway apparatus 4 in a learning state. The gateway apparatus 4 in the learning state repeats the process described below (S1220 to S1230).

The gateway apparatus 4 determines whether received information is any of sensor data, a control message, and status information (S1202).

When sensor data is received from the device 8 (S1202: Sensor data), the gateway apparatus 4 stores the sensor data in the device information management table 200 (S1204). In addition, the gateway apparatus 4 selects sensor data to be transmitted to the external service server 6 in the received sensor data and transfers the selected sensor data to the data center 2 (S1206).

When a control message is received from the external service server 6 (S1202: Control message), the gateway apparatus 4 stores the control message in the device information management table 200 (S1210). The gateway apparatus 4 transfers the received control message to the device 8 that is a destination (S1212).

When status information is received from the device 8 (S1202: Status information), the gateway apparatus 4 stores the status information in the device information management table 200 (S1220). In addition, the gateway apparatus 4 transfers the received status information to the inspection server 18 (S1222).

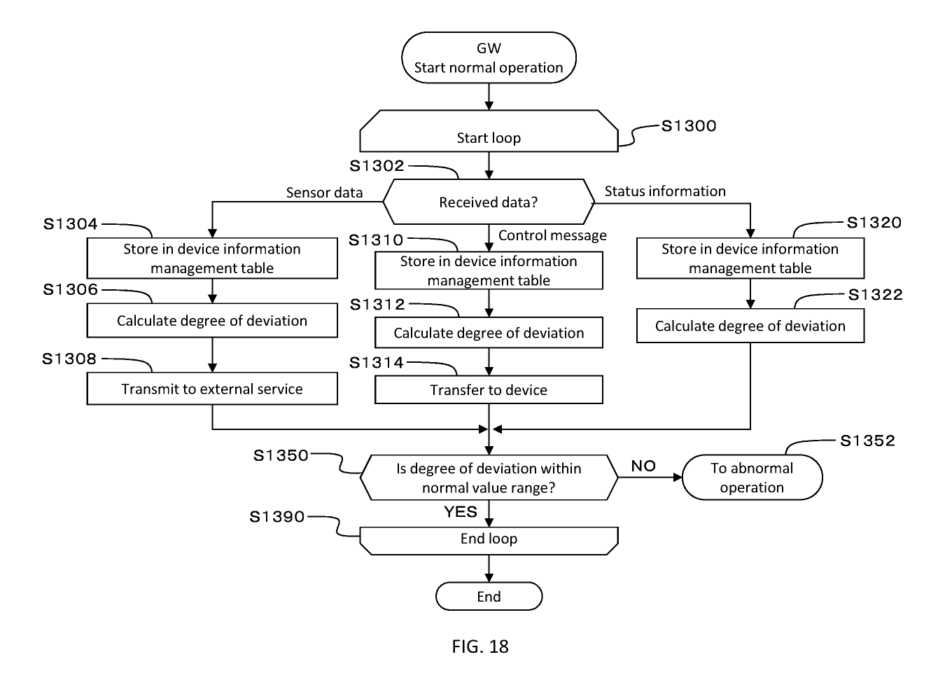

FIG. 18 is a flow chart showing an operation example of the gateway apparatus 4 in a normal operating state. The gateway apparatus 4 in the normal operating state repeats the process described below (S1300 to S1390).

The gateway apparatus 4 determines whether received information is any of sensor data, a control message, and status information (S1302).

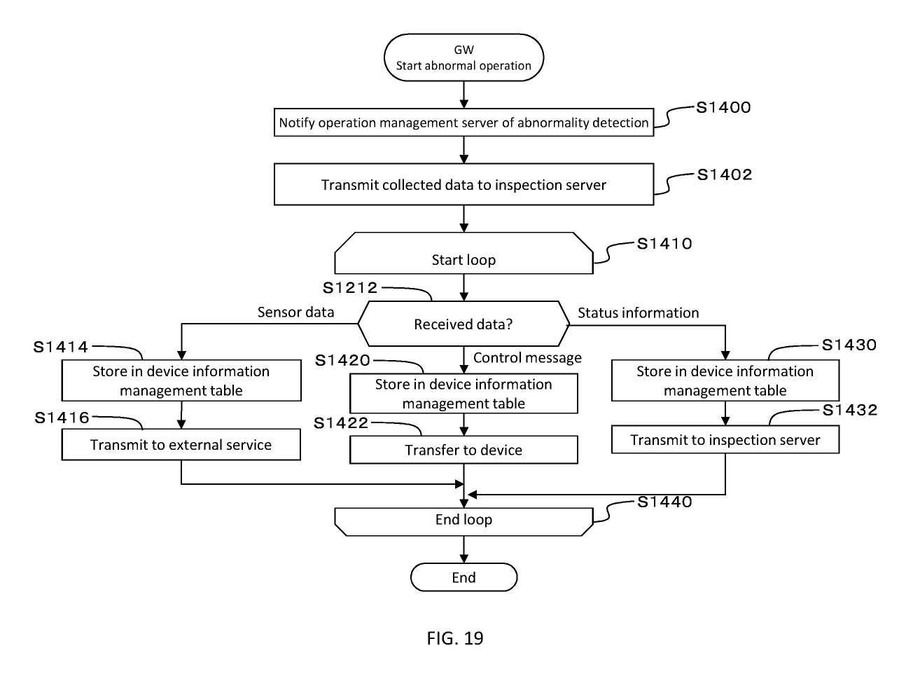

When sensor data is received from the device 8 (S1302: Sensor data), the gateway apparatus 4 stores the sensor data in the device information management table 200 (S1304). The gateway apparatus 4 refers to the normal value management table 300 and calculates a degree of deviation of the sensor data with respect to a normal value (S1306). The gateway apparatus 4 selects sensor data to be transmitted to the external service server 6 in the received sensor data and transfers the selected sensor data to the data center 2 (S1308). When the degree of deviation of the sensor data calculated in S1306 is not within the normal value range (S1305: NO), the gateway apparatus 4 makes a transition to an abnormal operating state (FIG. 19) (S1352).

When a control message is received from the external service server 6 (S1302: Control message), the gateway apparatus 4 stores the control message in the device information management table 200 (S1310). The gateway apparatus 4 refers to the normal value management table 300 and calculates a degree of deviation of the control message with respect to a normal value (S1312). The gateway apparatus 4 transfers the received control message to the device 8 that is a destination (S1340). When the degree of deviation of the control message calculated in S1312 is not within the normal value range (S1350: NO), the gateway apparatus 4 migrates to an abnormal operating state (FIG. 19) (S1352).

When status information is received from the device 8 (S1302: Status information), the gateway apparatus 4 stores the status information in the device information management table 200 (S1320). The gateway apparatus 4 refers to the normal value management table 300 and calculates a degree of deviation of the status information with respect to a normal value (S1320). When the degree of deviation of the status information calculated in S1320 is not within the normal value range (S1350: NO), the gateway apparatus 4 migrates to an abnormal operating state (FIG. 19) (S1352).

FIG. 19 is a flow chart showing an operation example of the gateway apparatus 4 in an abnormal operating state. The present process corresponds to a process after migrating to an abnormal operating state in S1352 in FIG. 18.

The gateway apparatus 4 notifies the operation and management server 12 of the fact that an anomaly has been detected (S1400). The gateway apparatus 4 transmits at least the collected data 214 with the data ID 208 for which an anomaly had been detected from the device information management table 200 to the inspection server 18 (S1402). The gateway apparatus 4 executes a process similar to S1200 to 51230 in a learning state (S1410 to S1440).

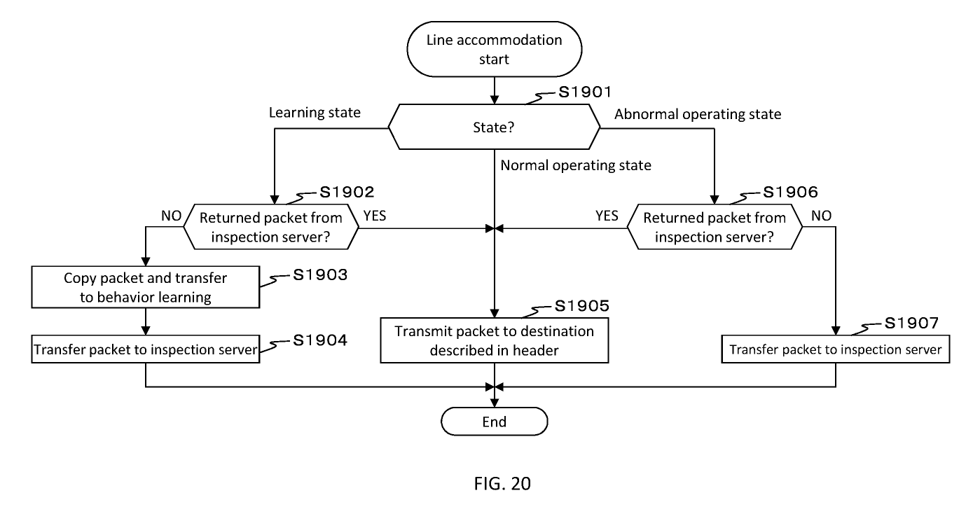

FIG. 20 is a flow chart showing an operation example of the line accommodation server 20 when receiving packet data. Moreover, an indication for a state transition of the line accommodation server 20 may be issued from the operation and management server 12.

When the line accommodation server 20 is in a learning state (S1901: Learning state), the line accommodation server 20 determines whether or not the received packet data has been returned from the inspection server 18 (S1902). When a result of the determination of S1902 is “YES”, the line accommodation server 20 transfers the packet data to a destination of a header (S1905), and ends the present process.

When the result of the determination of S1902 is “NO”, the line accommodation server 20 copies the packet data and transmits the copy to the behavior learning server 16 (S1903). Subsequently, the line accommodation server 20 transfers the packet data to the inspection server 18 (S1904), and ends the present process.

When the line accommodation server 20 is in a normal operating state (S1901: Normal operating state), the line accommodation server 20 transfers the received packet data to the destination of the header (S1905), and ends the present process.

When the line accommodation server 20 is in an abnormal operating state (S1901: Abnormal operating state), the line accommodation server 20 determines whether or not the received packet data has been returned from the inspection server 18 (S1906). When a result of the determination of S1906 is “YES”, the line accommodation server 20 transfers the packet data to the destination of the header (S1905), and ends the present process. When a result of the determination of S1906 is “NO”, the line accommodation server 20 transfers the packet data to the inspection server 18 (S1907), and ends the present process.

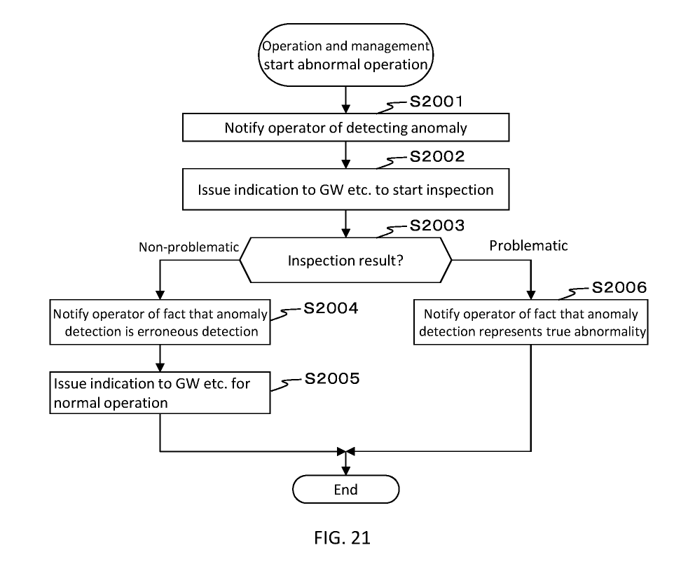

FIG. 21 is a flow chart showing an operation example of the operation and management server 12 in an abnormal operating state. The present process is a process following reception from the gateway apparatus of a notification of the fact that an anomaly has been detected 4 in FIG. 19.

The operation and management server 12 notifies the operator of the fact that an anomaly has been detected (S2001).

The operation and management server 12 issues an indication to start an inspection (to migrate to an abnormal operating state) to the gateway apparatus 4 having detected the anomaly, the line accommodation server 20, and the inspection server 18 (S2002).

The operation and management server 12 determines whether or not problematic data is present based on an inspection result received from the inspection server 18 (S2003).

When the operation and management server 12 determines that problematic data is present (S2003: Problematic), the operation and management server 12 notifies the operator of the fact that the anomaly detection in S2001 represents a true abnormality (S2006), and ends the present process. At this point, the operator may also be notified of contents of the abnormality.

When the operation and management server 12 determines that problematic data is not present (S2003: Non-problematic), the operation and management server 12 notifies the operator of the fact that the anomaly detection in S2001 represents an erroneous detection (S2004). In addition, the operation and management server 12 issues an indication to end the inspection (to make a transition to a normal operating state) to the gateway apparatus 4, the line accommodation server 20, and the inspection server 18 to which an indication had been issued in S2002 (S2005), and ends the present process.

The embodiment presented above merely represents an example for describing the present invention, and it is to be understood that the scope of the present invention is not limited to the embodiment. Those skilled in the art will recognize that various changes and modifications may be made in form and detail without departing from the spirit and scope of the claimed subject matter.

What is claimed is:

1. A computer system comprising a server apparatus, a gateway apparatus, and a plurality of devices coupled to the gateway apparatus, wherein:
the gateway apparatus is configured to
retain a normal value of a device, calculated based on device information which is information related to the device, for the plurality of devices, and
when device information related to a certain device is not included in a range of a normal value of the device, notify the server apparatus of the fact that an anomaly with respect to the device has been detected, and
the server apparatus is configured to,
when receiving from the gateway apparatus a notification of the fact that an anomaly has been detected, inspect device information related to the device in which the anomaly had been detected.

2. The computer system according to claim 1, wherein
the device information is any of first device information transmitted from a device to an external apparatus, second device information transmitted from an external apparatus to a device, and third device information transmitted from a device to the gateway apparatus.

3. The computer system according to claim 2, wherein
the server apparatus is configured to, when receiving from the gateway apparatus a notification of the fact that an anomaly has been detected, migrate from a normal operating state to an abnormal operating state, and
the server apparatus is configured
to inspect the first and second device information when in the abnormal operating state, but
not to inspect the first and second device information when in the normal operating state.

4. The computer system according to claim 2, wherein
the gateway apparatus is configured to, when in a learning state in which a range of a normal value of a device is learned, transmit the third device information to the server apparatus, and
the server apparatus is configured to, when in the learning state,
calculate a range of a normal value of each device based on at least one of the first, second, and third device information, and
transmit the calculated range of the normal value of each device to the gateway apparatus.

5. The computer system according to claim 4, wherein
the server apparatus and the gateway apparatus are configured to,
when a new device is coupled to the gateway apparatus, migrate to the learning state.

6. The computer system according to claim 4, wherein
the server apparatus and the gateway apparatus are configured to,
when a device of which a range of a normal value changes with the lapse of time is coupled to the gateway apparatus, migrate to the learning state at a prescribed timing.

7. The computer system according to claim 6, wherein
the device of which a range of a normal value changes with the lapse of time is a device of which a range of a normal value changes as seasons change.

8. The computer system according to claim 6, wherein
the device of which a range of a normal value changes with the lapse of time is a device of which a range of a normal value changes change due to age-related degradation.

9. The computer system according to claim 1, wherein
the server apparatus is configured to, in an inspection of device information with respect to a device in which the anomaly had been detected, determine whether or not the detection of the anomaly by the gateway apparatus is an erroneous detection.

10. A gateway apparatus to which a plurality of devices are coupled and which comprises a processor and a storage device, wherein
the storage device is configured to retain a range of a normal value of a device calculated based on device information which is information related to the device, for the plurality of devices, and
the processor is configured to, when device information related to a certain device is not included in a range of a normal value of the device, notify a prescribed server apparatus of the fact that an anomaly with respect to the device has been detected and cause the server apparatus to inspect the device information related to the device in which the anomaly had been detected.

11. A server apparatus capable of communicating with a gateway apparatus to which a plurality of devices are coupled, the server apparatus comprising a processor and a storage device, wherein
the processor is configured to,
when receiving from the gateway apparatus a notification of the fact that an anomaly has been detected, store device information related to the device in which the anomaly had been detected in the storage device, and
inspect the device information stored in the storage device, and determine whether or not the detection of the anomaly by the gateway apparatus is an erroneous detection.
